(19) United States
(12) Patent Application Publication
(10) Pub. No.: US 2009/0021131 A1
(43) Pub. Date: Jan. 22, 2009

(54) Lamp with high efficiency linear polarized light output

(76) Inventor: Daniel Lee Stark, San Jose, CA (US)

Correspondence Address: DANIEL LEE STARK, 1358 Pierce Ranch Road, San Jose, CA, 95120, US

(21) Appl. No.: 12/217,474

(22) Filed: Jul. 7, 2008

Related U.S. Application Data
(63) Continuation-in-part of application No. 08/919,641, filed on Aug. 28, 1997, now Pat. No. 6,268,685.

(51) Int. Cl. H01J 1/20; H01J 61/40

(52) U.S. Cl. 313/9; 313/112

(57) ABSTRACT

What is described is are two techniques to improve the efficiency of a lamp, one being energy recycling and the second being linear polarization recycling both of which can be implemented singularly or together in an incandescent or gas discharge lamp outputting an improved illumination and/or linear polarized illumination at a improved efficiency; the linear polarized lamp being desirable for use in an LCD projector and other applications requiring linear polarized illumination. The lamp utilizes one or more wasted energy recycling techniques. One technique is use of reflective polarization filter over the exit aperture that reflects wasted polarization back to the surface of the reflector wherein the polarization is partially randomized by the dielectric reflective coating on the lamp reflector for recycling and redirecting the polarized radiation back to the exit aperture; another technique is to place a candoluminescent material in proximity of the filament, housed in a transparent envelope, to intercept the wasted radiation and be heated to output desirable illumination via candoluminescence.

The processes described herein with the lamp reflector and the discriminative filters act as an energy trap, allowing only the desirable polarization and/or wavelengths to escape while the recycled polarization is randomized internal to the energy trap, and the wasted wavelengths are used to heat the candoluminescent material internal to the energy trap with the candoluminescent material acting as a secondary luminescence source.

### CROSS REFERENCE TO RELATED APPLICATIONS

The present application is a continuation-in-part (CIP) of patent application Pub. No. U.S. Ser. No. 08/919,641, filed Aug. 8, 1997, now U.S. Pat. No. 6,268,685, issued Jul. 31, 2001 all of which are incorporated herein in their entirety by reference.

### STATEMENT REGARDING FEDERALLY SPONSORED RESEARCH AND DEVELOPMENT

All research and development associated with this invention has been performed using private funds. No federally sponsored research or development has been used.

### BACKGROUND OF THE INVENTION

1. Field of Invention

The present invention relates to a design that improves the efficiency of an incandescent lamp and a design that converts an incandescent or gas discharge lamp to output a predominately linear polarized output by converting the radiation to a single linear polarization. The techniques can be used in synergy or independently. High efficiency lamps with linear polarized output are desirable in several applications such as in an LCD projector or potentially automobile headlights.

2. Description of Related Art

U.S. Pat. No. 4,539,505 Leslie A. Riseberg et. al., replaces the metal tungsten incandescent filament with resistive carbon doped candoluminescent material filament that heats to luminescence when an electrical current is applied. The candoluminescent filaments are lower temperature visible light generating sources. The lower temperature is possible because visible light is generated via luminescence rather then black body radiation. The product never became available on the market, which suggests it was not viable.

U.S. Pat. No. 5,124,286 John P. Edgar, et. al. describes the chemical content of a candoluminescent mantle for gas lamps. Visible light energy is generated by the heating action of the mantle by gas combustion. Edgar teaches the compositions of the different salts to be formed in the mantle to support candoluminescent action. Thorium is thus avoided which has the disadvantage of being radioactive.

U.S. Pat. No. 4,535,269 Charles D. Tschetter et. al. introduces use of a discriminative reflective filter formed to reflect and direct the wasted radiation to the filament for energy recycling. The design advantage is to provide a reflective discriminative filter, which allows the desirable wavelengths to transmit through the filter, and recycling of the wasted energy. The disadvantage is the difficulty of returning the energy to the filament, which is a small spatial target. The optical alignment accuracy required to recycle the energy to the filament makes the lamp not viable in the market place.

U.S. Pat. No. 5,160,199 Franaco Berti, describes a halogen lamp reflector wherein Franaco Berti teaches the basic geometric assembly of a projector light with a reflector and placement of the lamp and lamp filament. The reflector shape best supports a square output. A rectangular LCD pattern requires optics to fill the different projection pattern, which limits the projection to be mainly square.

U.S. Pat. No. 7,237,900 Ci Guang Peng et. al. describes a polarization conversion system using a technique that separates the polarizations, and redirects the wasted polarization to a phase retardation plate and recombines with the desired polarization. The technique requires quarter wave plates, which are wavelength specific, and complex optics geometry. The quarter wave plates need also be precisely placed in position and rotation. The major disadvantage is the complexity and precise micro positioning required to make the optic.

U.S. Pat. No. 7,312,913 Dec. 25, 2007 Serge Bierhuizen describes use of a reflective mirror polarizer and wavelength specific filters that reflect the wasted wavelengths and transmit the desirable wavelengths. For polarization recycling, the light is funneled through light tubes causing polarization randomization by multiple reflections off of the inner light tube surface prior to being redirected back to the exit apertures. The structure is complicated and accordingly expensive to fabricate. The light tubes are also funneled causing divergence and loss of directivity.

U.S. Pat. No. 6,208,451 Yoshitaka Itoh describes a polarization conversion system using a micro array that separates the polarizations and directs the unwanted polarization through a polarization conversion optic and recombines the energy with the desirable polarization. These techniques require a micro array of precise optics positioned and aligned. The quarter wave plates need also be precisely placed in position and rotation, and are difficult to fabricate, which increases costs.

U.S. Pat. No. 6,101,032 Wortman, et. al. describes use of a reflective polarizing mirror on the output of a fluorescent or incandescent lamp, used to reflect unwanted polarization back to within the lamp wherein the diffuse inner surface of the lamp causes polarization randomization on interactions, and subsequent exit at the desired polarization. The diffuse source consists of a light emitting region consistent with a fluorescent lamp with its inner coating which acts as a large scattering and depolarizing region. Wortman utilizes a diffuse surface, which is not consistent with a tungsten or gas discharge lamp. The drawings accordingly support a fluorescent lamp source rather than an incandescent tungsten or gas discharge lamp. Wortman describes a reflective filter returning wasted orthogonal polarization back to an incandescent light source; however, what is neglected is the very small spatial size the tungsten element projects, and accordingly the very small reabsorbtion of wasted orthogonal polarization. Wortman specifies lambertian reflection rather than specular reflection for the polarization randomization. Thus the reflected radiation that was nearly colliminated is also randomized in direction, which marginalizes its usefulness in applications such as an LCD projector or automobile headlight, which requires a directed output. For application to a incandescent lamp, polarization randomization is achieved if the filament source acts as a diffuse source and rejected polarization is returned to the filament for randomization. The filament is very small, which means the useful conversion is very small. Wortman neglects the capability of a dielectric coating on the reflector being able to randomize the polarization and maintain directivity of the returned orthogonal polarization, which has use for a tungsten or gas discharge lamp wherein the light source is spatially very small disallowing efficient reabsorbtion of the wasted energy by the filament or gas discharge arc.

U.S. Pat. No. 6,710,921 Hansen, et. al. describes a method to separate the polarizations using a reflective polarization mirror and redirect the wasted orthogonal polarization to a half wave plate for polarization conversion, then recombine the recycled polarization. The optic is a micro optic array and is difficult to build which drives cost.

U.S. Pat. No. 7,352,119 Berlin, describes an elliptical gas discharge lamp reflector for video projection. The shape is in the direction of the output illumination which provides a circular output pattern rather than a rectangular pattern.

U.S. Application Number. No. 61/128,298 of May 21, 2008 Stark, describes a method to convert polarization by use of reflection off of dielectric multilayers.

### SUMMARY OF THE INVENTION

What is described is an incandescent filament lamp or gas discharge lamp, for example, xenon with improved efficiency that can also be designed to output a linear polarized illumination at a high efficiency; the linear polarized output being desirable for use in an LCD projector and other instruments requiring linear polarized illumination such as automobile headlights. The lamp is composed of a electromagnetic source such as a filament or gas discharge, a reflector to direct the radiation generated by a filament or gas discharge into a directed output aperture, discriminative filters placed at the aperture reflect unwanted polarization and wavelengths back toward the source, with the addition of a candoluminescent structure, which acts as a secondary electromagnetic radiation output source when heated by outputting desirable wavelengths while being at a lower operating temperature than a tungsten filament. The optical coating on the reflector acts to randomize the reflected polarization while maintaining the specular nature of the reflection thus preserving the collimination and redirecting the radiation back to the output aperture. One or more of these techniques can be added to the lamp's design. The polarization conversion technique can be added to any lamp type wherein a reflector and a polarization mirror can be arranged.

The candoluminescent recycling techniques can also be readily applied to a general service lamp wherein columniation is not required, or linear polarized output light is not required. The candoluminescent material when placed in proximity to the filament or other light generating heat source is heated by the source and converts the heat directly to desirable wavelengths, adding to the lamp's color rendering and efficiency.

### BRIEF DESCRIPTION OF THE DRAWINGS

FIG. 1 is a transparent closed container used to contain the candoluminescent material within the lamp, with the candoluminescent material shown partially;

FIG. 2 is a side view that shows the tungsten filament formed on the transparent candoluminescent material container and the electrical connections;

FIG. 3 is a top view that shows the tungsten filament wrapped around the transparent candoluminescent material container with spacers between the tungsten filament and candoluminescent container;

FIG. 4 shows the assembled lamp with an outer transparent envelop, the tungsten filament wrapped around the transparent candoluminescent container, the electrical connector lamp pins;

FIG. 5 shows the assembled lamp using polarization and wavelength recycling composed of, a reflector to direct and colliminate the radiation, the fully assembled lamp being composed of the outer envelop, the tungsten filament wrapped around the inner candoluminescent container and electrical pins, as well of placement of the discriminative reflective film at the output aperture, and ray traces of output radiation and reflected radiation;

FIG. 6 shows a lamp wherein the filament is wrapped around the candoluminescent container, the outer envelope and the electrical connector pins arranged at each end of the lamp;

FIG. 7 shows the side cross section view of the polarized output lamp that outputs an elliptical projection pattern, complete with the reflector, the lamp, the inner container complete with candoluminescent material, the discrimination filters and ray traces of rejected illumination returned for polarization recycle and wavelength recycle;

FIG. 8 shows a front view of the lamp described in FIG. 7, showing the elliptical shaped reflector and placement of the lamp within the reflector;

FIG. 9 shows a xenon discharge lamp with the reflector and discriminative filter positioned to recycle rejected polarization as shown by ray traces;

FIG. 10 shows the optical schematic of an LCD projector complete with projection lamp, discriminative filters to reflect and recycle wasted energy and discriminative red, green blue filters used to separate the colors and direct the respective red, green and blue light to different paths, through the LCD crystal pixel arrays, not shown, and recombine the radiation for projection;

FIG. 11 shows a small diameter tubular, transparent, closed container for the candoluminescent material;

FIG. 12 shows the addition of a tungsten filament wrapped around the closed transparent candoluminescent container;

FIG. 13 shows an ordinary incandescent lamp with the addition of the candoluminescent container inside the lamp wherein wavelength recycling only is achieved.

### DETAILED DESCRIPTION OF THE INVENTION

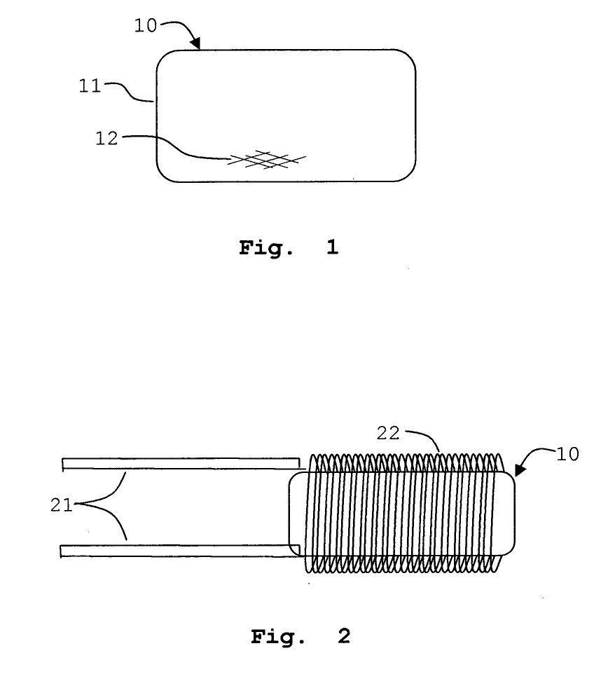

FIG. 1 Detailed Description

FIG. 1 shows an arbitrary shaped transparent candoluminescent closed container, 10, which is a composed of a transparent envelope, 11. The container, 10, is filled with a candoluminescent material, 12, doped on a low mass form such as a ceramic foam utilized in space shuttle tiles. The low mass allows rapid heating to candoluminescent activity similar to the current gas lantern. The drawing shows the candoluminescent material, 12, only in conceptual form in a small area inside the container, 10. The candoluminescent material generates visible light at a much lower temperature than a filament or gas discharge.

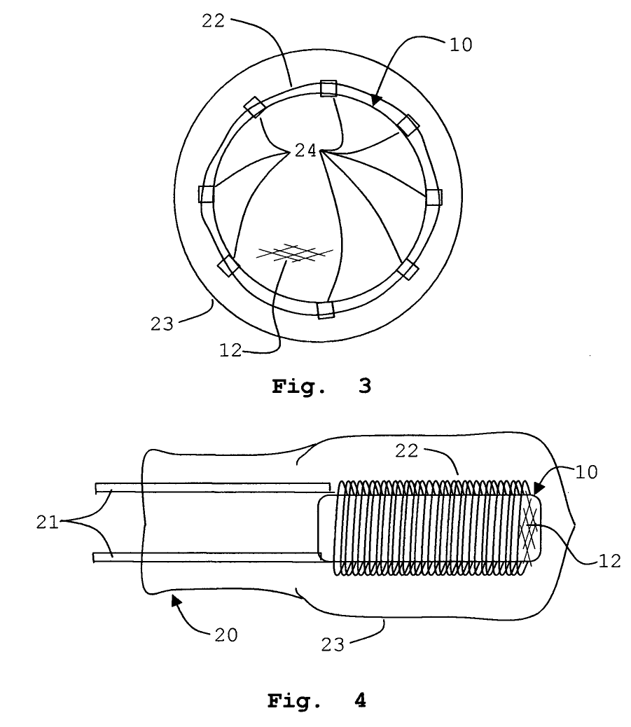

FIG. 2 Detailed Description

FIG. 2 shows the candoluminescent container, 10, with the tungsten filaments, 22, positioned around 10. The structure, 10, acts to maintain the filament 22 in position. The electrical contact leads are shown as plug in pins, item 21. However, the electrical contacts can be in many forms, and are not critical to the design described herein. The candoluminescent material inside of 10 is not shown in order to unclutter the drawing.

FIG. 3 Detailed Description

FIG. 3 shows a top view looking down of the assembly shown in FIG. 2 with the addition of the outer transparent envelope, 23. The inner candoluminescent container, 10, positions the tungsten elements, 22, wrapped around 10. Spacers, 24, are shown to maintain the filament, 22, in position around 10. The spacers are shown in concept and can be other forms such as a bar with slits to position each tungsten coil. The spacers are not critical to the design presented herein. The candoluminescent material, 12, inside of 10 is partially shown in order to unclutter the drawing.

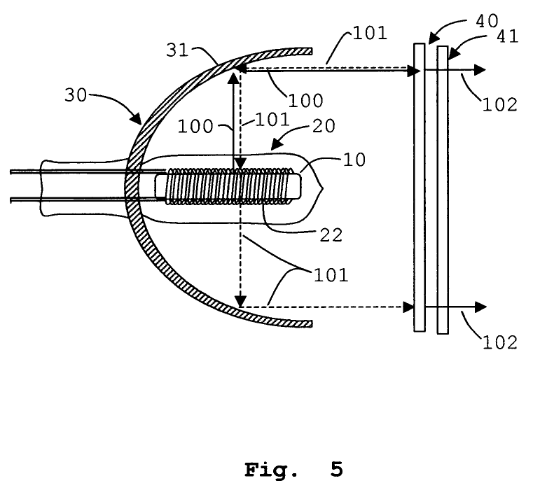

FIG. 4 Detailed Description

FIG. 4 shows a side view of the completed lamp assembly, 20. The outer transparent envelope, 23 holds the lamp's electrical contacts 21 in position. The contacts, 21 are used to support the candoluminescent container, 10. The tungsten filament coils, 22, are formed around 10. Spacers and the candoluminescent material, 12, inside the container, 10, is shown only partially in order to unclutter the drawing. The candoluminescent material typically should fill the container wherein the heat generated by the filament and energy redirected to 10 using energy recycling techniques, cause the candoluminescent material to emit visible radiation.

The candoluminescent envelope, 10, may also be placed in other positions such as outside of the filament. Multiple configurations of 10 are reasonable in the same lamp, not shown.

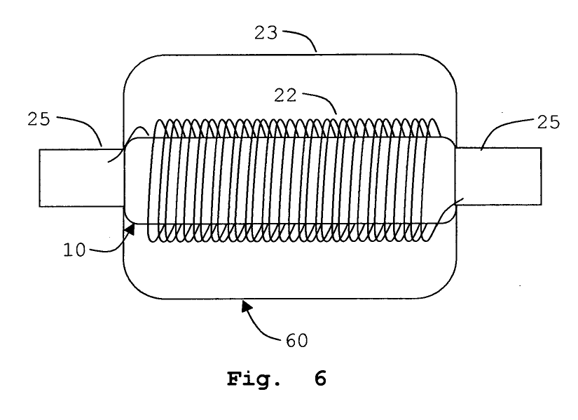

FIG. 5 Detailed Description

FIG. 5 shows a completed lamp, 30, as utilized in a projector and is an example of a tungsten filament lamp using the preferred polarization recycling embodiment with a reflector, 31, a reflective polarization filter, 40, as well as in addition the preferred wavelength recycling embodiment of a dichroic filter, 41 and a candoluminescent structure, 10. FIG. 5 shows two independent energy recycling techniques combined into a single design, however, both techniques need not be present. The independent recycling techniques are polarization recycling and wasted wavelength energy recycling. Both described below independently. However, the candoluminescent material also recycles partially the wasted polarization. Maximum efficiency is gained by applying both techniques.

The lamp, 20, is positioned inside the reflector, 31. The reflector, 31, acts to direct the output radiation, 100, generated by the lamp, 20, in a nearly colliminated manner to the output aperture. Positioned over the output aperture is a polarized mirror reflector, 40, which allows a single polarization to exit, 102, while reflecting the orthogonal polarization, 101, shown as the dotted line. The polarization filter, 40, may also be part of the lamp assembly or a second structure positioned at the lamps output aperture as shown. The orthogonal polarized ray, 101, is returned toward the lamp, 20 by the polarization filter, 40, which recycles 101 in several manners. The reflected ray's energy is recycled in a small degree by being absorbed by the filament, but it is preferable to miss the filament and internal lamp structure because of the low recycling efficiency gained. The reflected orthogonal ray, 101, is primarily recycled by reflection off of the reflector wherein the polarization is randomized by the dielectric multilayer coating, which is the most efficient recycling technique, and redirected back to the output aperture. The interaction with the reflector is specular in nature, which preserves the rays directivity, and redirects the ray 101 back to the output aperture wherein the cycle is repeated. The specular reflection is a major advantage over a diffuse reflection, which would also randomize the light path direction. Other coatings may be used on the reflector, which also randomizes the polarization such as metal with a coating; however these are not as efficient reflectors as a dielectric multilayer, which can be better than 99% reflectivity. A complex coating using a grated etched film may also be utilized, but the additional complexity does not offer sufficient benefit. Thus between the reflector 31 and polarization mirror 40, a polarized light trap is created that allows one polarization to escape through the output aperture and randomizes the trapped polarization for recycling when reflecting off of the dielectric multilayer on reflector 31. The reflections off of the reflectors dielectric multilayer coating convert the trapped orthogonal polarization to the desired polarization for output. The reflection efficiencies for the dielectric coating on the reflector 31, and on the polarization mirror can be very high, allowing for high polarization conversion efficiency. The multiple reflections between the polarization mirror, 40, and the reflector, 31, act to homogenize the light intensity spatially, providing a more even output illumination. If candoluminescent material is also present, any wasted polarization striking the candoluminescent material will act to heat the candoluminescent material and add to the lamp's efficiency; however, this effect is less efficient as the direct polarization conversion by reflection. The same is true for radiation impacting the tungsten filament, 22.

Briefly, a second energy recycling technique is use of a wavelength discrimination filter referred to as a dichroic reflector, 41, which reflects the wasted radiation such as infrared and transmits the desirable radiation such as visible. Items 10 and 41 provide the greatest efficient improvement for wasted wavelength energy recycling; however, can also contribute in a minor way to polarization recycling and may both be part of the lamp design, as shown. In detail, item 41 is a discriminative wavelength filter which allows the desirable wavelengths, such as visible, to transmit and reflects the wasted energy such as infrared. The dielectric coating on the inner part of 31 is designed to reflect the wasted wavelength energy and maintain directivity, which directs the energy, in the path shown as 101, back in a minor part to the filament, 22, and primarily to the candoluminescent container, 10. The reflected energy following a similar ray trace as 101 is partially absorbed by the filament, and primarily by the candoluminescent material inside of 10 wherein the energy is recycled via emission from the filament and emission via candoluminescence. A heat trap is formed by item 41 and 31 to convert the wasted energy into desirable wavelengths. The positions of 40 and 41 may be interchanged, and also may be part of the lamp design. Current projector lamp design used a dichroic filter with alternating layers of TiO2 and SiO2 that reflect greater than 99% if the visible light and transmit 90% of the infrared through the reflector which is made of a transparent material. The lamp is referred to as a cool lamp because the infrared is transmitted away from the projected visible radiation. If only polarization recycling is opted, the same cool lamp design is utilized using only the addition of the polarization mirror, 40 to the current design.

The candoluminescent material is placed in such a manner to maximize heating from all sources. The tungsten filament provides direct heating, therefore the candoluminescent material is placed in the center of the tungsten filament; however, this is not particularly necessary. The placement also takes advantage of the existing reflection paths between the lamp reflector, 31 and the dichroic filter, 41. Other placements are possible.

The polarization and wavelength conversion methods when both used constitute an example with greatest improved efficiency; however, either of one method may be utilized singularly.

FIG. 6 Detailed Description

FIG. 6 is an alternate design for a lamp, 60, that is formed as a tube with the candoluminescent structure 10, formed as an inner tube, and the filament, 22, wrapped around the length of 10. The filament, 22, is positioned the length of 10 with the lamp electrical connections, 25 shown at opposite ends of the lamp. The outer transparent envelope, 23, contains the inner candoluminescent container, 10, with the tungsten element, 22, formed around 10. FIG. 6 is a side view of the completed lamp, 60. The candoluminescent material inside of 10 is heated directly by the filament, 22. The candoluminescent material, not shown, inside of 10 acts as a second illumination source, by recycling mainly the heat generated by 22 into useful illumination.

The configuration shown is applicable to the tube style floor lamps and shows a method to recycle energy without the use of reflectors.

The candoluminescent envelope, 10, may also be placed in other arrangements such as outside of the filament. Multiple configurations of 10 are reasonable in the same lamp, not shown.

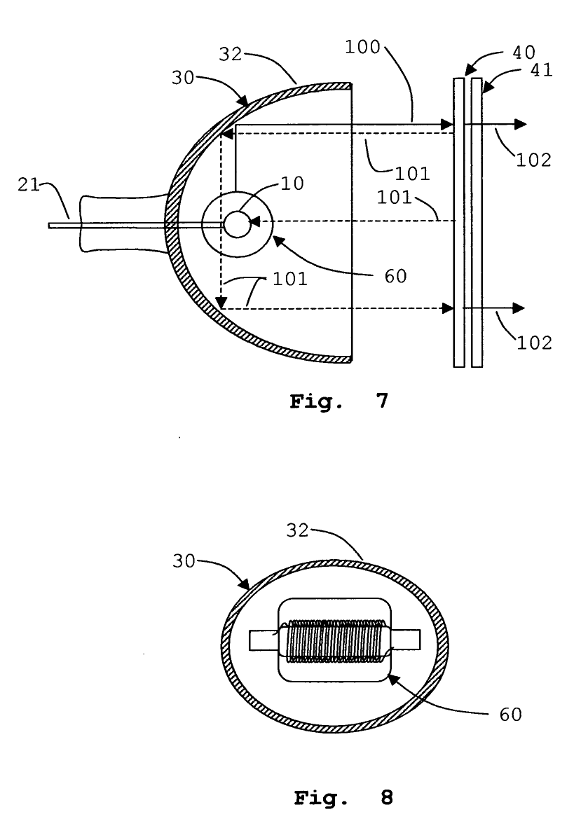

FIG. 7 Detailed Description

FIG. 7 is a lamp, 30, showing an example design taking full advantage of a elliptical shaped reflector that when used with a polarization mirror and a wavelength discriminative filter, recycle both the orthogonal polarization and the wasted wavelengths. The reflector 32 is formed to output an elliptical projected beam pattern as compared to a circular pattern. FIG. 7 is a side cross section showing the lamp, 60 positioned with respect to the reflector 30. The lamp 60 shows up as an end view in a cross section view of 30. The candoluminescent container 10 is shown inside of 60; the filaments wrapped around 10 are not shown. The candoluminescent material inside of 10 is not shown to unclutter the drawing.

Output radiation 100, generated by 60, reflects off of 30 and is directed to the polarization mirror 40. The polarization mirror passes the desirable linear polarization, 102, and reflects the orthogonal polarization shown by ray trace 101. Ray trace 101 reflects via specular reflection off of the inner dielectric coating on 32 wherein the polarization is randomized by the dielectric coating while the directivity is maintained. Ray path 101 is redirected back to the output aperture and polarization mirror 40, wherein the cycle is repeated. The dielectric is best composed of birefringent layers so that the P polarization, which predominantly enters internally to the multilayers, has its polarization randomized by the birefringent crystals that are part of the dielectric multilayer, such as rutile form of TiO2. Both P and S polarizations to a degree are reflected by the internal action of the multilayer, and both polarizations are randomized.

The candoluminescent structure, 10 is chiefly useful to recycle wasted wavelengths. By being in near proximity of the tungsten filament it is heated to output desirable radiation via candoluminescence. The addition of a wavelength discriminative filter, 41, over the output aperture recycles wasted wavelength energy such as infrared by directing the energy into the candoluminescent material inside of 10. The electrical connection tab, 21, is shown similar to an existing projection lamp, but is not of critical form to the design.

FIG. 8 Detailed Description

FIG. 8 is a front view of a lamp 30. The output beam pattern is elliptical rather than circular, to better fit the LCD projector requirements, which are rectangular. The lamp, 60 is shown positioned inside of the reflector 32.

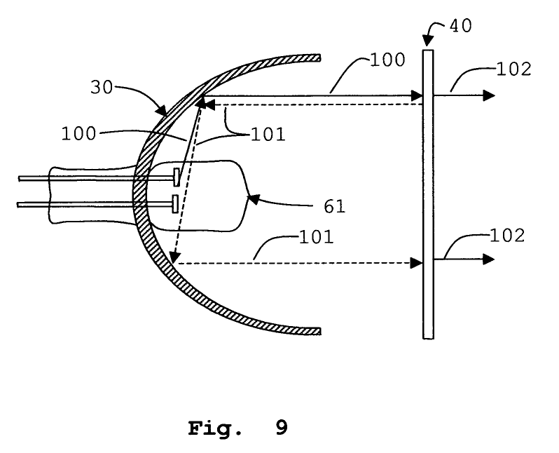

FIG. 9 Detailed Description

FIG. 9 is a side view of a polarization recycle discharge lamp, 61, such as a xenon lamp. FIG. 9 shows the preferred embodiment of the gas discharge lamp using the polarization recycle technique. The reflector, 30, is positioned with respect to the lamp, 61, in order to direct the radiation to an exit aperture where a discriminative polarization filter, 40, is placed. The radiation generated by the gas discharge, shown as ray path 100, is separated into two linear polarizations upon interaction with the polarization mirror, 40. The desirable polarization, 102, transmitted through the polarization filter, 40, while the orthogonal polarization, 101, is reflected by 40 for recycling by reflecting off of the dielectric multilayer applied on the inside of the reflector, 30. The recycled, reflected radiation shown as ray path 101, is redirected back to the polarization mirror, 40, where the entire cycle repeats. The returned orthogonal polarization, 101, reflects off of the reflector 30, wherein the multilayer dielectric coating randomizes the polarization while maintaining the reflectors directivity and redirects the ray 101 back to the exit aperture and the polarization mirror, 40.

The shape for an LCD projection application can be either elliptical or spherical, depending on the desired output projection shape.

Wavelength and candoluminescent material structures may also be added; however, the geometry requires the dichroic wavelength filter have some form to direct the wasted energy to a candoluminescent button. In this manner the two recycling techniques are more independent and do not augment each other.

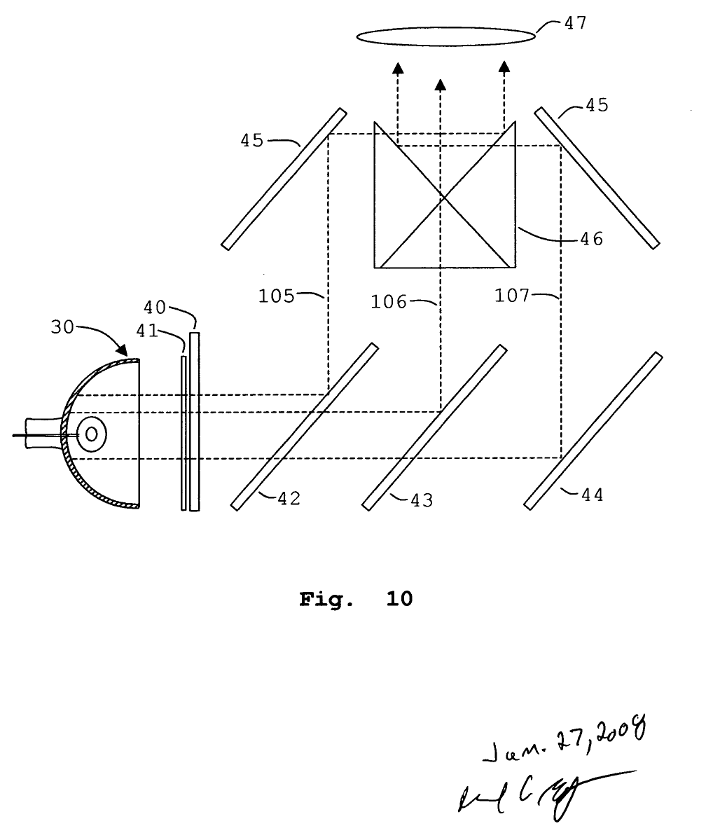

FIG. 10 Detailed Description

FIG. 10 is an optical schematic of an LCD projector that uses the tungsten or xenon gas discharge lamp, 30. Both types of reflective filters, polarization, 40, and wavelength, 41, are shown however both need not be present. Dielectric filters 42, 43 and 44 split the radiation into the blue, green and red spectrums. The ray paths 105, 106 and 107 show the respective blue, green and red ray paths. Mirrors 45 direct the blue and red colors to combine the colors using the optic 46, which directs the combined wavelengths to the projection lens assembly 47. The LCD panels are respectively placed in the blue, green and red, optical paths, and are not shown.

FIG. 11 Detailed Description

FIG. 11 is an alternate design for a candoluminescent container 10 that may be used in an ordinary incandescent lamp. The container 10 is transparent, and filled with candoluminescent material, 12, which is preferably formed on low mass foam such as ceramic foam.

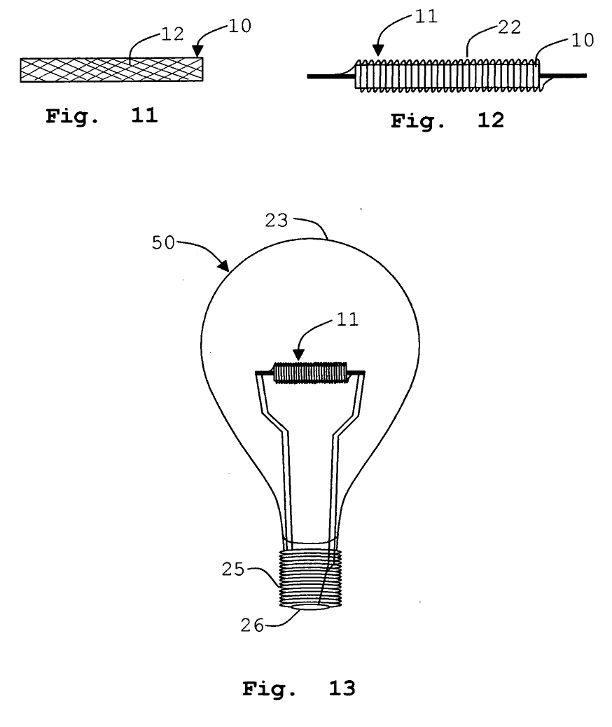

FIG. 12 Detailed Description

FIG. 12 is design utilizing a candoluminescent lamp element 11 that may be used in an ordinary incandescent lamp. The tungsten filament, 22 is wrapped around the candoluminescent container, 10, providing direct heating of the candoluminescent material included in the assembly, 11.

FIG. 13 Detailed Description

FIG. 13 is an ordinary incandescent lamp, 50, wherein the candoluminescent element, 11 is fitted into the lamp, 50. The tungsten filament, 22, heats the candoluminescent material to output visible radiation, and thus converts some of the radiant thermal energy directly into visible light. The lamp envelope, 23, is shown as a typical lamp as well as the socket that acts as the electrical leads 25 and 26. The lamp may be a standard halogen lamp incandescent lamp.

What is claimed is:

1. A polarized light source system comprising:
a lamp base with electrical connections;
a filament or gas discharge illumination source that generates illumination with the action of an electrical current flowing through the assembly;
a reflective polarizer to transmit light of one polarization state and reflect light of the orthogonal state;
a reflector shaped to provide concentrated directional output from the lamps source with such reflector having its inner surface coated with an optical coating to reflect the light;
wherein what is unique is the optical coating on the inner reflector is used to randomize the polarization;
wherein what is unique is the reflective polarization filter in conjunction with the lamp reflector act as a polarized radiation energy trap, converting the trapped radiation to the desired linear polarization and allowing the converted polarization to exit the energy trap;
wherein what is unique is the polarization randomization is achieved with an optical coating that does not randomize the direction by using specular reflection;
wherein what is unique is a dielectric coating of one or more birefringent materials is utilized to randomize the reflected radiation
wherein what is unique is the reflector may be shaped in a elliptical pattern to shape the output beam in a more rectangular pattern;
wherein what is unique is the multilayer optical coating on the reflector for either a filament or gas discharge luminescence source is utilized to randomize the reflected polarizations.

2. A light source system comprising:
a lamp base with electrical connections;
a filament or gas discharge illumination source that generates illumination with the action of an electrical current flowing through the assembly;
a candoluminescent structure in the lamp to act as a secondary luminescence source;
a dichroic filter, which transmit light wavelengths of a selected band and reflects light wavelengths of the undesirable band;
a reflector shaped to provide directional output from the lamps source with such reflector having its inner surface coated with an optical coating to reflect the wavelength band;
wherein what is unique is the reflective dichroic filter in conjunction with the lamp reflector act as a radiation energy trap, directing the trapped radiation to the candoluminescent structure and allowing the converted wavelength bands to exit the energy trap;
wherein what is unique is the reflector is shaped in a elliptical pattern or circular pattern to shape the output beam in a more rectangular pattern or circular to match the desired illumination application;
wherein what is unique is the candoluminescent material is housed in a inner transparent container;
wherein what is unique is the candoluminescent material may be placed in proximity of the filament, not requiring a reflector to recycle the energy, with the candoluminescent structure acting as a secondary luminescence source within the lamp heated to luminescence directly by the lamp filament.

3. A light source system comprising:
a lamp base with electrical connections;
a filament or gas discharge illumination source that generates illumination with the action of an electrical current flowing through the assembly;
a candoluminescent structure in the lamp to act as a secondary luminescence source;
a polarization mirror to transmit the desirable polarization and reflect the orthogonal polarization;
a filter to transmit the desirable wavebands and reflect the undesirable wavebands;
a internal candoluminescent secondary luminescence source that generates desirable illumination by one or more heat sources, the sources being direct heating by the filament, or recycled energy from the polarization filter, or recycled energy from the discriminative wavelength filter;
a reflector with polarization randomization ability;
wherein what is unique is the light source utilizes both polarization recycling and wavelength recycling;
wherein what is unique is the candoluminescent structure is heated by two or more methods, the methods being direct heating by the filament, or direct heating by the reflected polarization energy, or direct heating by the reflected wavelength energy;
wherein what is unique is use of candoluminescent material in a lamp to act as a secondary luminary source;
wherein the reflector may be of elliptical or circular shape to provide the desirable output shape.
